(19) United States
(12) Patent Application Publication
(10) Pub. No.: US 2014/0021809 A1
(43) Pub. Date: Jan. 23, 2014

(54) RELUCTANCE MOTOR

(71) Applicant: UT-Battelle, LLC, Oak Ridge, TN (US)

(72) Inventors: Timothy A. Burress, Maryville, TN (US); Curtis W. Ayers, Greenback, TN (US)

(73) Assignee: UT-Battelle, LLC

(21) Appl. No.: 13/944,731

(22) Filed: Jul. 17, 2013

Related U.S. Application Data
(60) Provisional application No. 61/672,824, filed on Jul. 18, 2012.

(51) Int. Cl. H02K 1/14; H02K 3/46

(52) U.S. Cl. CPC H02K 1/143; H02K 3/46
USPC 310/46

(57) ABSTRACT

Some exemplary reluctance motors disclosed herein comprise a rotor having a plurality of radially outwardly projecting rotor poles and a plurality of generally U-shaped stator units positioned circumferentially around the rotor. Each stator unit is spaced circumferentially apart and magnetically isolated from adjacent stator units. Each stator unit comprises a circumferentially extending yoke and two stator poles extending radially inwardly from the yoke, such that the stator poles are positioned adjacent to the rotor poles. The motor further comprises a plurality of coils of electrical conductors, wherein each of the coils is coiled around a respective one of the yokes of the stator units. In some embodiments, non-magnetic stator supports are positioned between the stator units and configured to engage circumferential sides of the stator units to hold the stator units in radial and circumferential alignment with the rotor.

### CROSS REFERENCE TO RELATED APPLICATION

This application claims the benefit of U.S. Provisional Patent Application No. 61/672,824, filed on Jul. 18, 2012, which is incorporated by reference herein.

### ACKNOWLEDGMENT OF GOVERNMENT SUPPORT

This invention was made with government support under Contract No. DE-AC05-00OR22725 awarded by the U.S. Department of Energy. The government has certain rights in this invention.

### FIELD

This disclosure relates to electric machines and more specifically to electric motors that utilize magnetic reluctance.

### BACKGROUND

Conventional switched reluctance motors (SRMs) have a cylindrical stator that surrounds a rotor within the stator. The stator typically includes a fully cylindrical outer body, also known as the “yoke” or “back-iron,” and a plurality of stator poles that project radially inwardly from the outer body. The rotor includes outwardly projecting rotor poles that differ in number from the plurality of stator poles. Such SRMs typically include independently controlled electrical windings positioned around each of the inwardly projecting stator poles. The different windings are variably energized to create variable magnetic flux paths to drive the rotation of the rotor. Typically, each of the flux paths travel circumferentially through the same cylindrical outer body of the stator between varying sets of energized stator poles. For example, in a conventional 12-8 SRM, when four stator poles are activated, each flux paths travels 90° through the outer body of the stator between activated poles, such that flux is observed around the entire 360° of the outer body of the stator at the same time.

### SUMMARY

Described herein are exemplary embodiments of switched reluctance motors (SRMs), including embodiments of Multiple Isolated Flux Path (MIFP) SRMs. Also disclosed are winding techniques, structural designs, and control concepts, which can provide improved performance, specific power, power density, and/or other features. Various coil winding configurations and stator support features are disclosed. MIFP SRMs can facilitate various novel electrical control techniques since the torque overlap between phases can be considerable. Such control techniques can provide torque ripple reduction, acoustic noise reduction, and/or other advantages.

Some exemplary reluctance motors disclosed herein comprise a central rotor having a plurality of radially outwardly projecting rotor poles and a plurality of stator units positioned circumferentially around the rotor. The stator units are spaced circumferentially apart and magnetically isolated from adjacent stator units. Stator units can comprise a circumferentially extending yoke and two stator poles extending radially inwardly from the yoke, such that the stator poles are positioned adjacent to the rotor poles. The motor further comprises a plurality of coils of electrical conductors, wherein at least one of the coils is coiled around one of the yokes of the stator units.

In some embodiments, the stator units comprise a generally U-shaped lamination stack and the stator units are magnetically isolated from one another.

In some embodiments, the coils comprise an outer portion and an inner portion, the outer portion being located along a radially outer side of the respective yoke and the inner portion being located along a radially inner side of the respective yoke between the two stator poles. The outer portion of the coil can have a radial thickness that is less than a radial thickness of the inner portion of the coil and the outer portion of the coil can have a circumferential width that is greater than a circumferential width of the inner portion of the coil. The outer portion of the coil and the inner portion of the coil can have about the same cross-sectional area perpendicular to current flow through the coil.

In some embodiments, each stator unit is associated with only one coil. In some embodiments, each stator pole comprises a circumferentially lateral side that faces away from an opposing stator pole of the same stator unit and a circumferentially medial side that faces the opposing stator pole of the same stator unit, and the circumferentially lateral sides of the stator poles are free of the coils.

In some embodiments, the motor further comprises an annular body, such as a cooling jacket, positioned along radially outer surfaces of the outer portions of the coils, that is configured to remove heat from the outer portions of the coils.

In some embodiments, the stator units further comprise first and second ridges projecting radially outwardly from the yoke along circumferentially lateral sides of the outer portions of the coils.

In some embodiments, the motor comprises a plurality of non-magnetic stator supports positioned between the stator units and configured to engage circumferential sides of the stator units to hold the stator units in alignment with one another and the rotor. The stator supports can be generally wedge shaped and/or taper in circumferential width moving radially inward. The stator units can comprise first and second circumferentially extending support projections that engage with corresponding support recesses in the adjacent stator supports. The motor can further comprise first and second axial end supports, or plates, positioned on opposing axial sides of the plurality of stator supports, wherein the axial end supports retain the plurality of stator supports in a fixed alignment relative to one another and relative to the rotor, thereby retaining the plurality of stator units in a fixed alignment relative to one another and relative to the rotor.

Disclosed embodiments can provide many advantages over conventional SRMs. For example, disclosed embodiments can provide increased power density, reduced noise, reduced torque ripple, reduced overall size and weight, simplified and lower cost manufacturability, improved heat transfer, improved ease of winding coils around stator units, improved ease of removing and inserting individual stator units, increased available space between stator units for placement of other components, and/or reduced of flux leakage between stator components. The foregoing and other objects, features, and advantages of this technology will become more apparent from the following detailed description, which proceeds with reference to the accompanying figures.

### BRIEF DESCRIPTION OF THE DRAWINGS

FIG. 1 is a diagram illustrating an exemplary 12-10 multiple isolated flux path (MIFP) switched reluctance motor (SRM).

FIG. 2 is a partial view of the diagram of FIG. 1, showing an exemplary stator with yoke winding.

FIG. 3 is a perspective view of an exemplary embodiment of a 12-10 MIFP SRM with yoke windings.

FIG. 4 shows a cross-sectional profile of the rotor and one stator of an exemplary 12-10 MIFP SRM disclosed herein.

FIG. 5 is a perspective view of an exemplary 12-10 MIFP SRM disclosed herein, with one stator and other components not shown for clarity.

FIG. 6A-6D show various components and sub-assemblies of an exemplary 12-10 MIFP SRM disclosed herein.

FIG. 7 shows the components and sub-assemblies of FIGS. 6A-6D in an assembled view.

### DETAILED DESCRIPTION

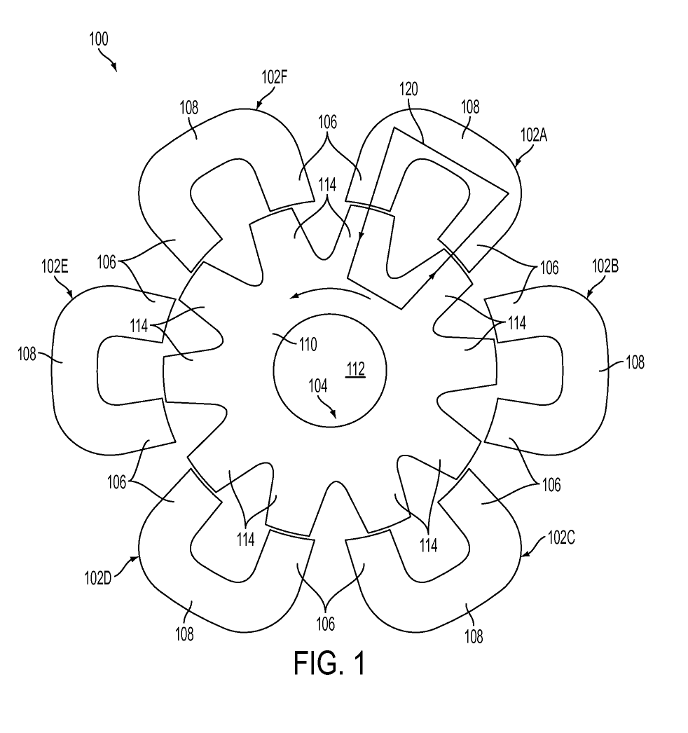

FIG. 1 illustrates an exemplary multiple isolated flux path (MIFP) switched reluctance motor (SRM) 100 having twelve stator poles and ten rotor poles, and is therefore referred to as a “12-10” MIFP SRM. In other embodiments, MIFP SRMs can comprise many other combinations of the number of stator poles and the number of rotor poles, such as 8-6, 10-8, 18-15, and 24-18 for examples, without departing from the novel and nonobvious inventions described herein. Disclosed embodiments are not limited by the number of stator poles or rotor poles present, unless expressly stated otherwise.

Using the 12-10 embodiment of FIG. 1 as an example, the motor 100 includes six stator units 102A-102F and a rotor 104. Each stator unit 102 comprises two generally radially inwardly projecting stator poles 106 coupled together by a generally circumferential yoke 108, forming a generally U-shape when viewed in the axial direction. The rotor 104 comprises an inner body 110 that extends circumferentially about a central opening 112 and comprises ten rotor poles 114 extending generally radially outwardly from the inner body 110. The stator units 102 can have continuous wire coils wrapped around the yokes 108 to create magnetic flux within the respective stator units and the rotor. The wire coils can comprise any electrically conductive material, such as copper or silver. However, specific references to copper coils in this disclosure are only exemplary and do not limit any of the described embodiments to comprising copper. Further, the rotors and stator units described herein can comprise any magnetically conductive material, such as steel or iron. However, specific references to steel stator units and/or steel rotors in this disclosure are only exemplary and do not limit any of the described embodiments to comprising steel.

Some or all of the stator units 102A-102F can be magnetically isolated from one another. For example, non-magnetic material and/or air-filled space can be positioned between the stator units 102. This prevents a direct flux path between adjacent stator units. Instead, flux paths are localized to a single stator unit 102 and travel around the U-shaped path of the individual stator unit. An exemplary isolated flux path 120 is shown in FIG. 1, which passes through the two poles 106 and the yoke 108 of stator unit 102A. Because the flux paths in a MIFP SRM are localized by the isolated stator units, the flux paths have a shorter path length (and thus reduced reluctance) relative to conventional SRMs having a one-piece, fully cylindrical stator outer body, or “back-iron.”

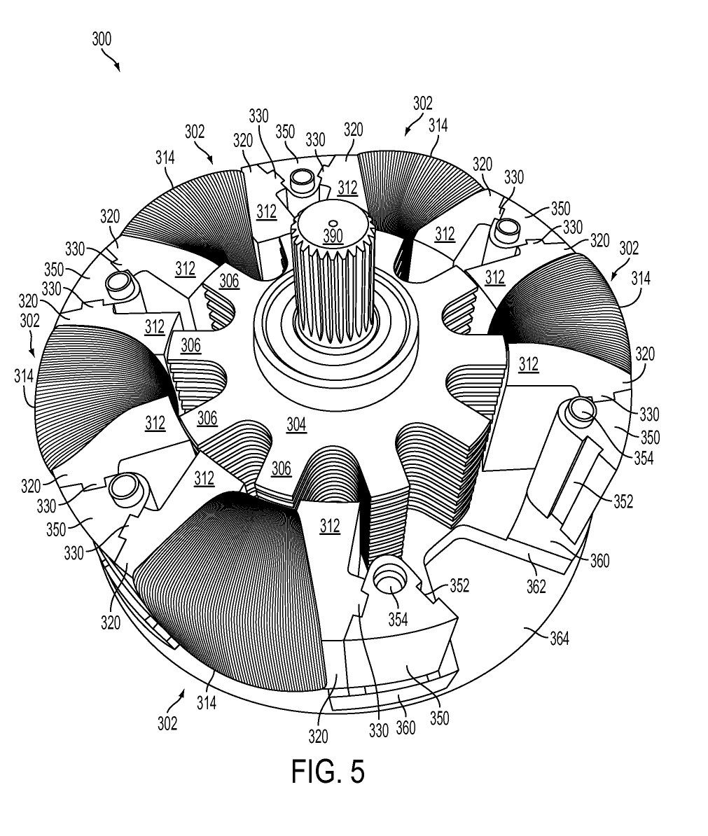

In MIFP SRM embodiments described herein, the rotor and the stator units can comprise stacks of several thin layers, or laminations, of magnetic material that are built up in the axial direction to provide a desired axial depth. See the rotor 304 in FIG. 5, for example. A primary advantage of such laminated construction is to reduce eddy current losses in the magnetic material by reducing the electrical path in the axial direction.

Three significant energy loss factors in SRMs are hysteresis, eddy currents, and “copper” losses. For a given excitation level and frequency, hysteresis and eddy current losses are generally proportional to the length of the flux path. Therefore, a MIFP SRM can have reduced hysteresis and eddy current losses relative to conventional SRMs since the flux path lengths in a MIFP SRM are shorter. Furthermore, hysteresis loss is generated from molecular friction when magnetic particles in the metal are subject to a reversal of magnetic field. For some MIFP SRM configurations, such as 12-10 embodiments, there can be essentially no flux reversal in the stator units, and therefore minimal hysteresis losses. This can be a significant advantage when compared with conventional flux reversal frequencies in conventional SRMs, which can be three or more times the electrical frequency, since all phases share the same cylindrical outer stator body. Additionally, disclosed MIFP SRMs can have a smaller amount of wasted copper at the end-turns compared to conventional motors since the phase windings do not overlap each other and thus can have lower copper (I²R) losses than what is typical for permanent magnet or induction machines, as well as reduced weight, volume, and cost from reduced copper amounts. Other benefits of disclosed MIFP SRMs include low material and manufacturing costs, high durability, and torque versus speed performance similar to permanent magnet machines.

In some embodiments of a MIFP SRM, one or more of the stator units includes two continuous wire coils, one positioned around each of the two stator poles 106. For example, in a 12-10 MIFP SRM, each of the twelve stator poles can have an individual coil wrapped around it. The two coils on the two stator poles of a stator unit can be electrically coupled in series, and such pairs of coils can be electrically coupled in series or in parallel with other pairs of coils in the same phase.

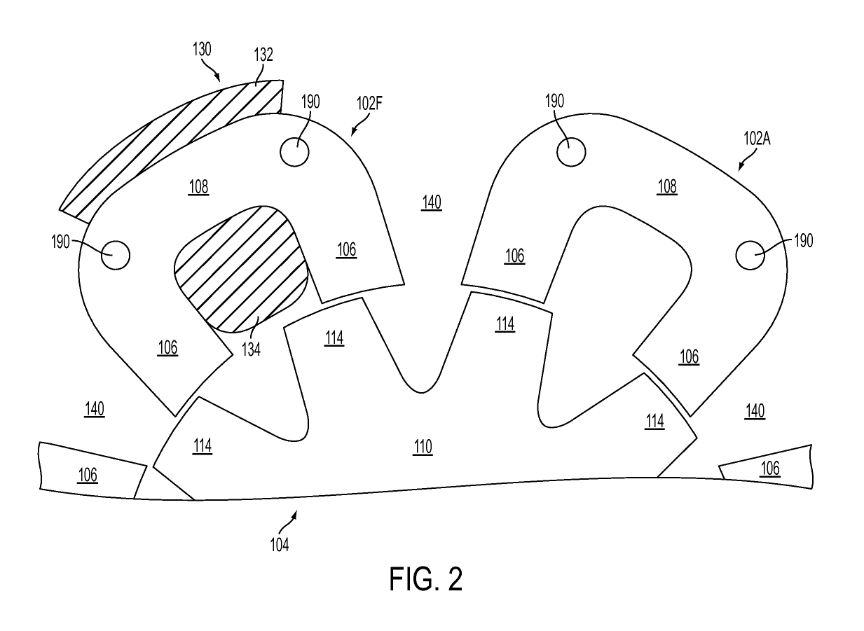

In other embodiments of a MIFP SRM, one or more of the stator unit comprises a continuous wire coil positioned around the yoke portion of the stator unit. For example, FIG. 2 shows a portion of the MIFP SRM 100 shown in FIG. 1 with a wire coil 130 wrapped around the yoke 108 of the stator unit 102F. This yoke winding configuration can allow for the two stator poles 106 of a stator unit to not have coils wrapped around them. In other embodiments, both the stator yokes 108 and the stator poles 106 can have coils wrapped around them.

As shown in FIG. 2, the yoke coil 130 has an outer portion 132 positioned radially outward of the yoke 108, and an inner portion 134 positioned radially inward of the yoke and between the stator poles 106. The outer portion 132 and inner portion 134 are portions of the same continuous wire coil 130 that wraps around the yoke 108. In the view of FIG. 2, the portion of the coil 130 extending in front of the yoke 108 between the outer portion 132 and the inner portion 134 is not shown for illustrative purposes, and only the cross-section outlines of the outer portion 132 and the inner portion 134 taken along a plane perpendicular to the rotational axis of the rotor 104 and passing through the center of the yoke 108 are shown Because the outer portion 132 and the inner portion 134 are cross-sections of the same continuous wire coil 130, they can include about the same total number of individual conductors and thus the area of the outer portion 132 can be about equal to the area of the inner portion 134 even though their shapes differ.

As shown in FIG. 2, the outer portion 132 of the coils 130 can be spread over a broader circumferential width than the inner portion 134, as the inner portion 134 is laterally constrained by the two stator poles 106. Consequently, having about the same total area, the outer portion 132 can have a radial thickness that is substantially less than that of the inner portion 134. A lesser radial thickness of the outer portion 132 can allow for a lesser overall radial dimension of the motor, which can allow the motor to be made smaller and lighter for a given torque or power output and can therefore facilitate lighter, smaller, faster, more spacious, and/or more energy efficient vehicles and other devices.

MIFP SRM embodiments having coils positioned around the yokes of the stator units can provide various advantages relative to embodiments having coils positioned around the stator poles. These advantages can include improved heat transfer. Copper has a thermal conductivity that is approximately 40 times higher than steel. Thus, by having the outer portions 132 of the coils located radially outwardly of the yokes 108, the outer portions 132 of the coils can readily interface with a cooling structure, such as a heat exchanger, located radially outward of the stator units. By contrast, in motors wherein each stator pole includes an individual coil wrapped around it, the heat generated by the coils has to travel through the material of the stator before reaching the cooling structure located radially outwardly of the stator. In some embodiments, the outer portion 132 of the yoke coils 130 can be in direct contact with, or adjacent to, a cooling structure positioned radially outwardly of the stator units. Such improvement of heat transfer can allow for increased power density and specific power for the motor since higher output power can be obtained with an equivalently sized motor.

Another advantage of yoke-wound coils is manufacturability. Coils 130 can be wound around the yokes 108 of the individual “U” shaped stator units 102 before the stator units are installed in the support structure of the motor. This can make the winding process quicker, easier and less expensive. Also, the coils 130 can be machine wound around the yokes 108 by rotating the individual stator units 102 (about the axis of the yoke) while a feed of the coil wire is caused to become wrapped around the yoke. In motors having coils wrapped around the stator poles, by contrast, the coils are typically hand-wound around the stator poles or pre-wound away from the stators and subsequently slid over the stator poles. Winding a coil wire directly around the stator poles is more difficult because the opposing stator pole interferes with the winding path and can therefore require sophisticated equipment and/or tedious manual labor. Additionally, the pole-wound approach can require the interconnection of the two separate coils on each stator unit, whereas this can be avoided with the yoke-wound approach.

Furthermore, individual stator units 102 can be readily removed from and inserted into the motor without having to remove or insert other stator units. For example, an individual stator unit can be removed from the motor to replace or fix a damaged portion and then the individual stator unit can be reinserted into the motor without having to remove and reinsert other stator units. Further, each stator unit can be individually wound with a coil separate from the rest of the motor and inserted into the motor one at a time. By contrast, individual removal or manipulation of stator units is not possible with motors having a one-piece stator unit with a fully circumferential back-iron.

Another advantage of having coils 130 positioned around the yokes 108 of the stator units 102 instead of around the stator poles 106 is that the stator poles can be wider since the coils are not located on the outer-lateral side of the stator poles between adjacent stator units. Wider stator poles can allow for the torque production from each phase to be broader, increasing the overlap of torque production among phases. This can also increase the overall torque, and facilitates the reduction of torque ripple and acoustic noise reduction. Wider stator poles 106 can also allow for wider rotor poles 114, which can be more mechanically substantial, resulting in a reduction in vibration and acoustic noise.

Another advantage of having coils 130 positioned around the yokes 108 of the stator units 102 instead of around the stator poles 106 is that more loops of a single coil can be located in the middle of the stator units 102 between the poles 106 since two different coils do not share this same volume. Because individual stator units 102 include a single yoke-wound coil 130, the issues of winding two coils in place through the same volume or installing two pre-wound coils onto the stator poles can be avoided. Using two pole-wound coils can result in compromises on fill factor. Additionally, some applications using pole-wound coils may require the two coils to be separated from each other with an insulation material to keep the coils electrically isolated and/or mechanically protected from vibration. The increased fill factor provided by using a single yoke-wound coil instead of two pole-wound coils that share the same space can allow for a corresponding increase in power density and/or specific power for the motor.

Another advantage of having coils 130 positioned around the yokes 108 of the stator units 102 instead of around the stator poles 106 is that it can facilitate acoustic noise damping techniques. Since the spaces between the adjacent stator units 102, indicated as 140 in FIG. 2, can be devoid of coils, in some embodiments noise damping materials or structures can be incorporated into these spaces. For example, an epoxy, rubber, other polymeric material, composite materials, or other materials can be positioned between adjacent stator units to dampen noise and/or attenuate vibration. This can also allow some acoustic energy to be dissipated in the damping material as opposed to being transmitted through a rigid support structure that holds the stator units in place.

In some embodiments, the spaces 140 between the stator units 102 can be used in other ways. For example, the spaces 140 can be used to locate coolant passageways or other cooling mechanisms, additional separate coils, magnets configured to counteract magnetic leakage, electronics and controllers, and/or other features.

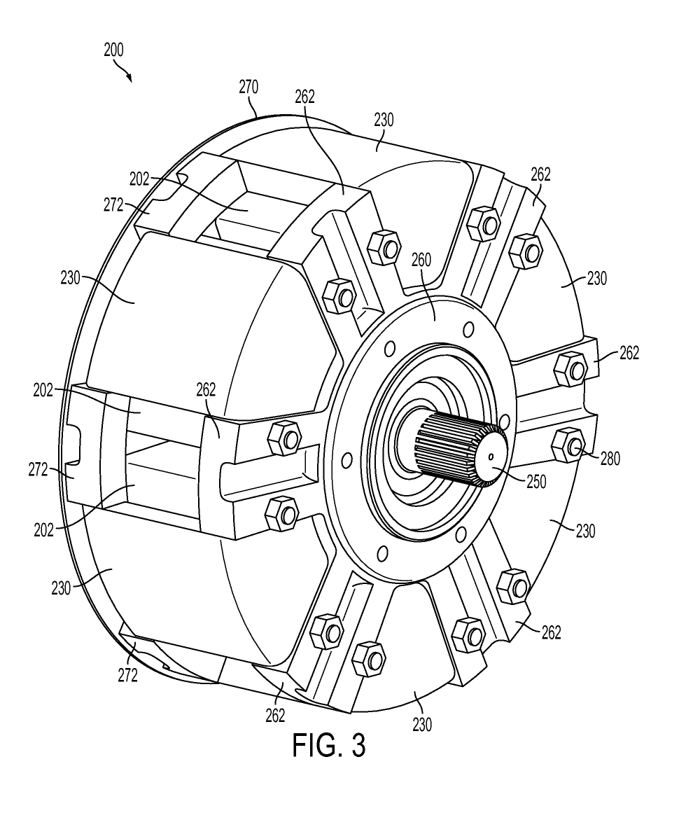

FIG. 3 shows an exemplary embodiment of a 12-10 MIFP SRM 200 having yoke-wound coils 230. The motor 200 comprises six U-shaped stator units 202 each supporting one of coils 230 wrapped around its yoke. The stator units 202 are spaced circumferentially around a central rotor (hidden) mounted on a drive shaft 250. The motor 200 further comprises a first structural support 260 having support arms 262 that is mounted around the drive shaft on one axial side of the rotor and stator units 230, and a second structural support 270 having support arms 272 positioned on the opposite axial side of the rotor and stator units. The structural supports 260, 270 cooperate to hold the rotor and stator units in alignment, such as via bolts or dowels (one of which is indicated as 280) passing axially through the support arms 262, 272 and through apertures in the stator units 202. FIG. 2 shows exemplary apertures 190 in the stator units 102 for securing the stator units to support structures via bolts or dowels. As shown in FIG. 3, the yoke-wound coils 230 can form a wedge shape around the yokes of the stator units 202, and can occupy the regions between adjacent support arms 262 and the regions between adjacent support arms 272.

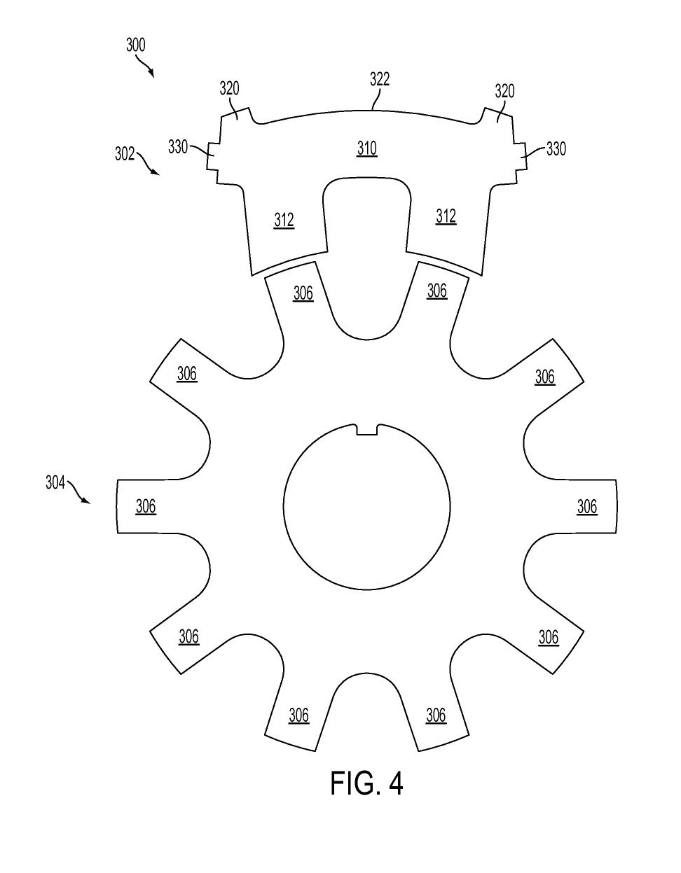

FIG. 4 shows a profile of a stator unit 302 and a rotor 304 of another exemplary 12-10 MIFP SRM 300, taken along a plane perpendicular to rotational axis of the rotor. Only one of six stator units 302 is shown for illustrative purposes. The stator 302 includes a yoke 310 and two stator poles 312. As shown, the stator units 302 can include opposing ridges 320 circumferentially spaced apart and extending radially outwardly from the radially outer surface of the yoke 310. The ridges 320 can extend axially along the stator unit and can form a trough 322 between the ridges 320 along the radially outer surface of the yoke 310. The trough 322 can receive the outer portion of a yoke-wound coil (not shown in FIG. 4) similar to the yoke-wound coil 130 shown in FIG. 2, while the ridges 320 can provide lateral bracketing for the outer portion of the coil. The radial dimension of the trough 322 can be about equal to the radial dimension of the outer portion of the coil.

FIG. 5 shows perspective view of an exemplary 12-10 MIFP SRM 300 as illustrated in part in FIG. 4. In the example of FIG. 5, one of six stator units 302 is not shown for illustrative purposes. Each of the stator units 302 includes a yoke-wound coil 314 positioned between the radially projecting ridges 320. In other embodiments, fewer than all of the stator units can include a yoke-wound coil.

The motor 300 can further comprise stator supports positioned circumferentially around the motor in the regions between the stator units 302. Such stator supports can be generally wedge shaped to conform to the shape of open regions between the stator units. The supports can be configured to structurally support one or both adjacent stator units 302. For example, as shown in FIG. 5, wedge-shaped stator supports 350 are located between the stator units 302. The Stator supports 350 can comprise two axially extending slots 352 that receive corresponding axially extending ridges 330 projecting from the adjacent stator units. One or more of the supports 350 can further comprise axially extending apertures 354 for receiving bolts or dowels (e.g., 280 in FIG. 3) that secure the stator supports 350 to end supports 360, 370 on either axial side of the motor (only one of the end supports 360 is shown in FIG. 5).

Because one or more of the stator units 302 can be secured in place via the ridges 330 engaging with the supports 350, these stator units can be free of axial bolt apertures (such as the apertures 190 in FIG. 2), which can improve the magnetic flux path through the stator units, can reduce eddy currents, can make removal and insertion of individual stator units from the motor easier, and/or can reduce the chance of short circuits occurring between laminations. Furthermore, the stator units 302 can be more readily removed from and inserted into the motor compared to motors wherein bolts or dowels extend axially through apertures in the stator units themselves to secure the stator units to the front and rear support plates. In the embodiment 300, individual stator units can simply be slid axially between the two adjacent stator supports to remove or insert the stator unit, without having to remove the stator supports or having to unfasten axial dowels extending through the stator units. This provides a modular configuration for improved assembly and maintenance.

In some embodiments, the ridges 330 on the stator units 302 and/or the slots 352 in the supports 350 can be replaced by engagement features other than axially extending ridges, such as any engagement features that restrict the motion of the stator units in the radial and circumferential directions. For example, the ridges 330 can be replaced with prongs, tabs, or other non-axially extending projections and the slots 352 can be replace with corresponding recesses. In other embodiments, the stator units 302 can comprise recesses and the supports 350 can comprise projections, or a combination of both. Desirably, the engagement between the stator units 302 and the supports 350 is such that the circumferential spacing of the stator units can be maintained and such that the radial spacing of the stator poles 312 from the rotor poles 306 can be maintained. In some embodiments, bolts, screws, latches, or other mechanisms can be included to secure the engagement between the stator units 302 and the stator supports 350.

Similarly, the engagement between the supports 350 and the end supports 360, 370 can comprise an interface that is sufficient to restrict the motion of the supports 350 and stator units 302 in both the radial and circumferential directions, as well as in the axial direction.

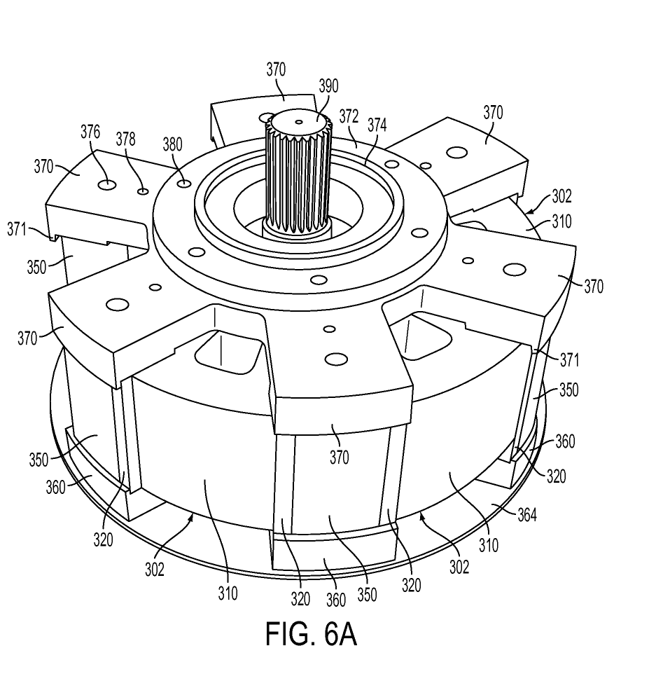

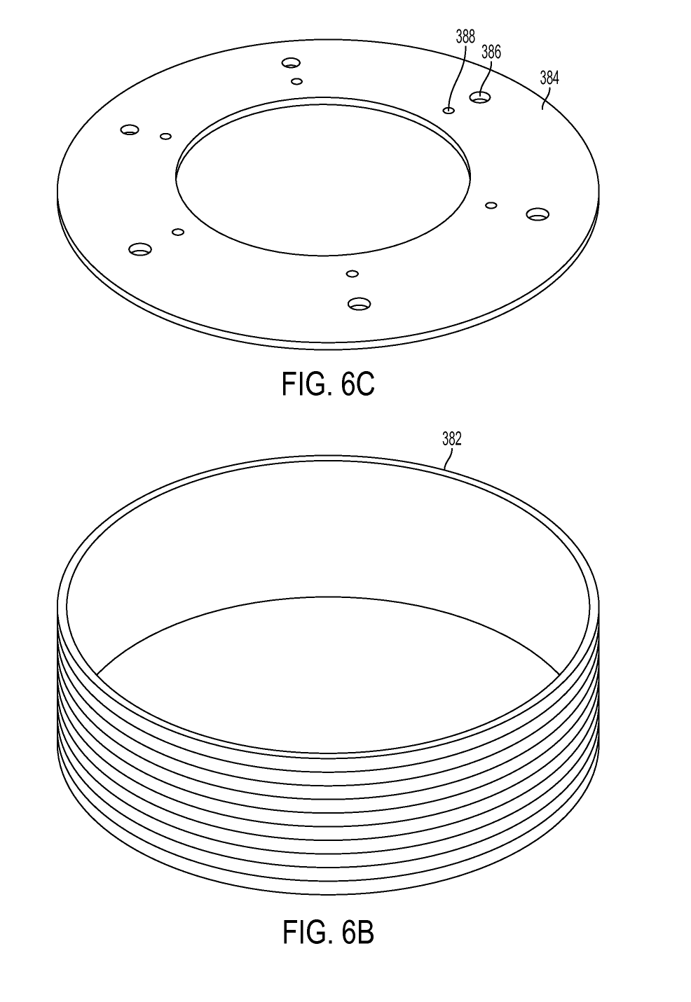

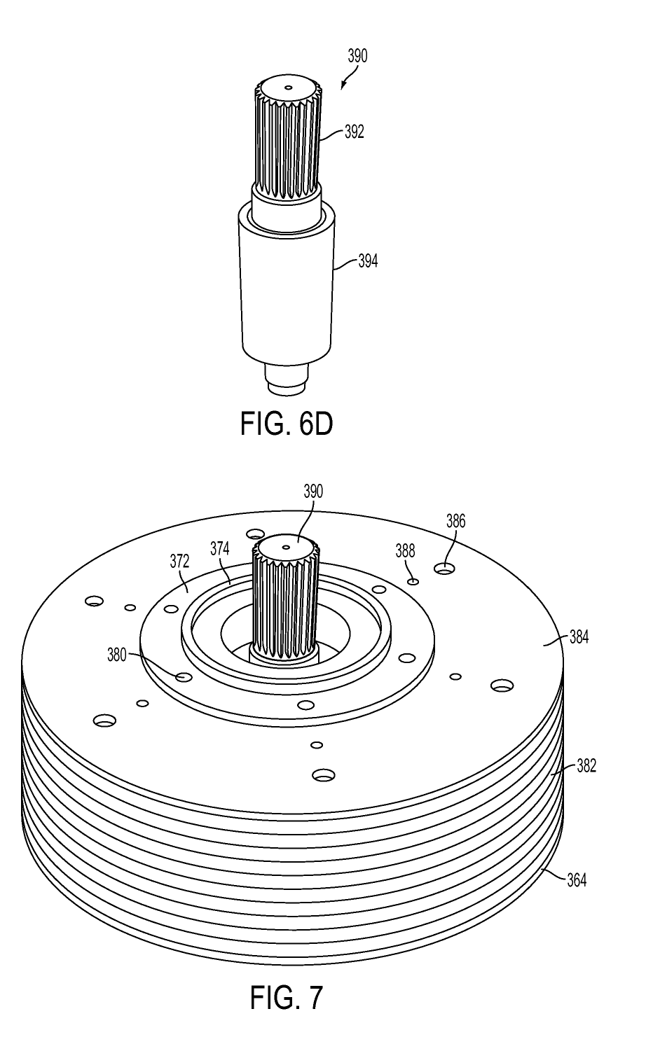

FIG. 6A shows the motor 300 with both end supports 360 and 370 included, but without the coils 314 and some of the stator units 302. One or both of the end supports 360, 370 can comprise radial arms that engage with the stator supports 350 at one or more axial ends of the stator supports. One or both of the supports 360, 370 can further comprise spaces between such arms to accommodate the bulk of the coils 314. The end support 370 can optionally include an axially raised central annular portion 372 and a further raised ridge 374, as shown in FIG. 6A, such as to form mounting configurations for the motor. In addition, one or both of the end supports 360, 370 can comprise openings 376 for receiving dowels or bolts or other projections extending axially from the apertures 354 of one or more of the stator supports 350. One or both of the end supports 360, 370 can further comprise apertures 378, 380 for coupling additional components to the motor and/or as passageways for wires or conduits. The radial ends of the arms of one or both of the end supports 360, 370 can comprise axially extending lips 371 that overhang the radially outer surfaces of stator supports 350 and/or the ridges 320 of stator units 302 to provide addition securement of the stator units in radial relation to the rotor.

FIGS. 6B-6D show exemplary additional components of the motor 300. FIG. 7 shows the assembly of these components in the motor 300. FIG. 6B shows an annular body 382 that is positioned around the radially outer surfaces of the end supports 360, 370 and/or the outer portion of the coils 314. The annular body 382 can contain, protect, and/or provide cooling for the motor 300. For example, the annular body 382 can comprise a cooling jacket/heat exchanger having an inner surface that is in contact with the coils 314 and draws heat away from the coils and/or dissipates the heat. In other examples, an outer surface can include grooves and/or scallops for improved convective cooling, and/or can include troughs for liquid cooling tubes.

As shown in FIG. 6A, the motor 300 can include an end plate 364 positioned at one axial side of the motor adjacent the end support 360. FIG. 6C shows a second end plate 384 that can be positioned opposite the end plate 364 adjacent and the end support 370. The opposing end plates 364, 384 can contact opposite sides of the annular body 382 to help secure it in place. The end plates 364, 384 can be secured to the end supports 360, 370, respectively, with bolts or other fasteners. The end plate 384 can be positioned around and radially outwardly of the raised portion 372 of the end support 370. The end plate 384 can comprise apertures 386, 388 that align with the apertures 376, 378 in the end support 370, and the end plate 364 can also comprise similar apertures. The end plates 364, 374 and the annular body 382 can together substantially envelope other components of the motor 300, with the motor shaft 390 and/or other associated components protruding axially from the end plate 384.

FIG. 6D shows the motor shaft 390, which can comprise an inner portion 394 that is coupled to the rotor 304 and an outer portion 392 that is couplable to another device to transfer torque from the motor 300. The inner portion 394 can comprise a slot, groove, or other positive engagement feature that mates with a corresponding feature on a radially inner surface of the rotor 304. The outer portion 392 can comprise a gear-like outer surface having positive registration features for mating with another component or another device.

The MIFP SRMs disclosed herein can be controlled using novel electrical control techniques due to the considerable torque overlap between phases and other novel characteristics. Such control techniques can provide torque ripple reduction, acoustic noise reduction, and/or other advantages. An exemplary system can comprise at least one MIFP SRM as described herein that is electrically coupled to at least one controller and an electrical power source. The controller can comprise computing hardware, such as a processor, memory, and programmed control logic in the form of software and/or other computer readable instructions stored in the controller or a storage device associated with the controller.

In some embodiments, control algorithms can be used to optimize control waveforms as a function of speed and torque of the motor. This can allow for near-zero torque ripple at least for low and moderate torque levels, such as up to about 150 Nm in some embodiments, and greater torque levels in other embodiments, and can allow for reduced torque ripple at all torque levels.

Dynamic testing of an embodiment similar to the embodiment 300 shown in FIGS. 5 and 6 has shown that it exceeds 2015 targets of the U.S. Department of Energy for power density (at least 5 kW/L), specific power (at least 1.3 kW/kg), and motor cost per kW (less than $7/kW). Exemplary test results indicate a power density of about 5.6 kW/L or more, a specific power of 1.45 kW/kg or more, and an efficiency of about 93% or more for 124.4 Nm at 4,000 rpm can be achieved. Furthermore, a torque ripple of about 5% or less can be achieved with a torque of about 125 Nm at 4,000 rpm, producing about 52.4 kW. At 8,000 rpm, a torque ripple of about 20% or less can be achieved for 75 kW and a torque ripple of about 30% or less can be achieved for 90 kW.

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatuses, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods.

As used herein, the terms “a”, “an” and “at least one” encompass one or more of the specified element. That is, if two of a particular element are present, one of these elements is also present and thus “an” element is present. As used herein, the term “and/or” used between the last two of a list of elements means any one or more of the listed elements. For example, the phrase “A, B, and/or C” means “A,” “B,” “C,” “A and B,” “A and C,” “B and C” or “A, B and C.” As used herein, the term “coupled” generally means physically or electrically coupled or linked and does not exclude the presence of intermediate elements between the coupled or associated items absent specific contrary language.

Unless otherwise indicated, all numbers expressing properties, sizes, percentages, measurements, distances, ratios, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, numbers are not approximations unless the word “about” is recited.

In view of the many possible embodiments to which the disclosed principles may be applied, it should be recognized that the illustrated embodiments are only preferred examples and should not be taken as limiting the scope of the disclosure. Rather, the scope of the disclosure is at least as broad as the scope of the following claims. We therefore claim all that comes within the scope of these claims.

1. A reluctance motor comprising:
a rotor having a plurality of radially outwardly projecting rotor poles and being rotatable about a central rotation axis;
a plurality of stator units positioned circumferentially around the rotation axis and radially outwardly of the rotor, each stator unit being spaced circumferentially apart from adjacent stator units, wherein each stator unit comprises a circumferentially extending yoke and two stator poles extending radially inwardly from the yoke, such that the stator poles are positioned adjacent to the rotor poles;
a plurality of coils of electrical conductors, wherein at least one of the coils is coiled around one of the yokes of the stator units.

2. The motor of claim 1, wherein the stator units each comprise a generally U-shaped lamination stack and the stator units are magnetically isolated from one another.

3. The motor of claim 1, wherein each coil comprises an outer portion and an inner portion, the outer portion being located along a radially outer side of the respective yoke and the inner portion being located along a radially inner side of the respective yoke between the two stator poles.

4. The motor of claim 3, wherein the outer portion of the coil has a radial thickness that is less than a radial thickness of the inner portion of the coil.

5. The motor of claim 3, wherein the outer portion of the coil has a circumferential width that is greater than a circumferential width of the inner portion of the coil.

6. The motor of claim 3, where the outer portion of the coil and the inner portion of the coil have about the same cross-sectional area perpendicular to current flow through the coil.

7. The motor of claim 1, wherein each stator unit is associated with only one coil.

8. The motor of claim 1, wherein each stator pole comprises a circumferentially lateral side that face away from an opposing stator pole of the same stator unit and a circumferentially medial side that faces the opposing stator pole of the same stator unit, and the circumferentially lateral sides of the stator poles are free of the coils.

9. The motor of claim 3, wherein the motor further comprises an annular cooling jacket positioned along radially outer surfaces of the outer portions of the coils and is configured to remove heat from the outer portions of the coils.

10. The motor of claim 3, wherein each stator unit further comprises first and second ridges projecting radially outwardly from the yoke along circumferentially lateral sides of the outer portions of the coils.

11. The motor of claim 1, further comprising a plurality of non-magnetic stator supports positioned between the stator units and configured to engage circumferential sides of the stator units to hold the stator units in radial and circumferential alignment with one another.

12. The motor of claim 11, wherein the stator supports are generally wedge shaped and taper in reduced circumferential width moving radially inward.

13. The motor of claim 11, wherein each stator unit comprises first and second circumferentially extending support projections that engage with corresponding support recesses in the adjacent stator supports.

14. The motor of claim 11, further comprising first and second axial end supports positioned on opposing axial sides of the plurality of stator supports, wherein the axial end supports retain the plurality of stator supports in a fixed alignment relative to one another and relative to the rotor, thereby retaining the plurality of stator units in a fixed alignment relative to one another and relative to the rotor.

15. A multiple isolated flux path reluctance motor comprising:
a generally U-shaped stator lamination stack disposed radially outwardly of a rotor lamination stack, said stator stack having a radially outer portion that faces away from the rotor stack and a radially inner portion that faces the rotor stack;
a continuous wire coiled about said lamination stack around the radially inner and outer portions; and
wherein a radially outer portion of the coiled wire is spread about the radially outer portion of the stator stack such that the radial extent of the radially outer portion of the coiled wire is less than the radial extent of a radially inner portion of the coiled wire at the radially inner portion of the stator stack.

16. The motor of claim 15, wherein the stator stack comprises two stator poles projecting radially inwardly from a yoke portion, and wherein the radially inner portion of the coiled wire is positioned between the two stator poles.

17. The motor of claim 15, further comprising an annular body positioned around the stator stack and the rotor and having a radially inner surface engaged with the radially outer portion of the coiled wire to remove heat from the coiled wire.

18. A multiple isolated flux path reluctance motor comprising:
a first stator lamination stack having a first tab;
a second stator lamination stack having a second tab that faces the first tab;
a non-magnetic support column disposed between said first and second lamination stacks, said support column having a pair of slots that face the first and second tabs; and
wherein the tabs cooperate with the slots such that the column supports the first and second stator lamination stacks and prevents movement of the first and second stator lamination stacks relative to one another.

19. The motor of claim 18, wherein the support column tapers from a broader radially outer end toward a narrower radially inner end.

20. The motor of claim 18, further comprising first and second axial supports positioned on opposing axial ends of the support column, wherein the first and second axial supports retain the support column in a fixed alignment relative to a rotor lamination stack, thereby retaining the first and second stator lamination stacks in a fixed alignment relative to the rotor.

21. A multiple isolated flux path reluctance motor comprising:
a rotor having a plurality of radially outwardly projecting rotor poles and being rotatable about a central rotation axis;
a plurality of generally U-shaped stator units positioned circumferentially around the rotation axis and radially outwardly of the rotor, each stator unit being spaced circumferentially apart from adjacent stator units, wherein each stator unit comprises a circumferentially extending yoke and two stator poles extending radially inwardly from the yoke such that the stator poles are positioned adjacent to the rotor poles, each of the stator units further comprising support tabs projecting circumferentially from opposing ends of the yoke;
a plurality of coils of electrical conductors, wherein each of the yokes has one of the coils coiled around it, wherein each coil has an outer portion along a radially outer surface of the respective yoke and an inner portion along a radially inner surface of the respective yoke, and wherein the outer portion of each coil has a first radial thickness and the inner portion of each coil has a second radial thickness that is greater than the first radial thickness; and
a plurality of stator supports positioned between the stator units, each stator support comprising slots that engage the support tabs of the two adjacent stator units such that the stator supports hold the stator units in a fixed radial and circumferential position within the motor.
